(19) United States
(12) Patent Application Publication
(10) Pub. No.: US 2026/0242268 A1
(43) Pub. Date: Aug. 20, 2026

(54) METHOD OF PROCESSING DRINKING WATER TREATMENT MATERIAL

(71) Applicant: Reale Lime, Sylvania, OH (US)

(72) Inventors: Charles Stansley, Greytown, OH (US); Andrew Stanley, Sylvania, OH (US); Edward Moore, Toledo, OH (US)

(21) Appl. No.: 19/541,151

(22) Filed: Feb. 16, 2026

Related U.S. Application Data
(60) Provisional application No. 63/759,432, filed on Feb. 17, 2025.

(51) Int. Cl. C02F 11/122; C02F 5/02; C02F 11/13; C02F 11/16; C02F 101/20; C02F 101/30; C05D 3/02; C05D 5/00; C05D 9/02; C05F 7/00; C05G 5/40; C09K 17/50

(52) U.S. Cl. CPC C02F 11/122; C02F 11/13; C02F 11/16; C05D 3/02; C05D 5/00; C05D 9/02; C05F 7/005; C05G 5/40; C09K 17/50; C02F 5/02; C02F 2101/203; C02F 2101/206; C02F 2101/30; C02F 2303/18

(57) ABSTRACT

A method of processing drinking water treatment material is disclosed. The drinking water treatment material is produced as a byproduct of a water treatment softening processing typically employed by a water treatment facility. The byproduct drinking water treatment material is typically in the form of a sludge. The methods include receiving the DWTM sludge; lagoon storage of the sludge with foreign matter removal; dewatering by plate-and-frame filtration and/or lagoon pumping with crocks and ditching, amongst various other dewatering methods; conditioning various methods, such as by laydown, windrowing, and drying, for example; and screening to yield a sized fraction for agricultural or industrial use, including VRT field application. In certain embodiments, the dried drinking water treatment material or “filter cake” is then pelletized into generally uniform granules for further field application.

### FIELD

The present disclosure relates to drinking water treatment material, and more particularly to a method of processing drinking water treatment material to expand its applications across different sectors.

### BACKGROUND

Drinking water treatment material (DWTM) is also known as spent lime, lime sludge or lime residuals. DWTM is a byproduct of the water softening process in municipal water treatment plants and presents significant opportunities for beneficial reuse. A typical water treatment process produces potable water using raw water from a water source. Lime residuals are produced during the precipitative softening process and are removed from the water stream by clarifiers. The residuals are distributed to a dewatering location or to one or more storage lagoons. As part of the water treatment process, lime is used for softening purposes. The lime is primarily used for reducing water hardness, which is caused by the presence of dissolved calcium and magnesium ions. The softening process involves the addition of high calcium lime (e.g., Carmeuse lime and stone) to the water to precipitate these ions. Adding lime to the water and gently mixing it during the flocculation process allows for the formation of flocs, which are larger aggregates of the precipitated particles. The water is then allowed to sit in a sedimentation basin where the heavy flocs can settle out of the water by gravity. The precipitated solids (known as lime softening residuals) are collected from the sedimentation basin and distributed as described hereinabove to the one or more storage lagoons or to a sludge dewatering facility where the material is mechanically dewatered (i.e., pressed).

Municipal water treatment plants generate substantial quantities of DWTM, which is primarily composed of calcium carbonate. Traditionally, it was considered a waste product and would be disposed of in landfills. However, recent progress has been made to demonstrate that DWTM can be used for various beneficial uses and promote landfill avoidance, thereby reducing both disposal costs and environmental impact.

Accordingly, it would be desirable to develop a method of processing DWTM to expand its applications across different sectors.

### SUMMARY

In harmony and accordance with the present disclosure, a method of processing drinking water treatment material (DWTM) to expand its applications across different sectors, has been newly developed.

In particular, the present disclosure provides a practical and sustainable pathway to convert DWTM from a municipal softening byproduct into value-added products that are readily handled, stored, and applied using conventional equipment. By increasing the solids content, removing foreign debris, and producing a sized and optionally pelletized product, the method diverts significant volumes of byproduct from a municipal water treatment process from landfills, reduces disposal and transportation costs, conserves liming resources, and improves environmental outcomes. The resulting materials serve as effective agricultural soil amendments to neutralize acidity and improve tilth and water retention, function as phosphorus sorbents in runoff mitigation structures, and act as stabilizers or neutralizing agents in construction and industrial processes, thereby creating both economic and environmental benefits for municipalities and end users.

The present disclosure provides a method of rendering DWTM from sludge and preparing it for application and, in certain embodiments, for pelletization. The method includes receiving and storing DWTM sludge, dewatering by using various techniques, such as lagoon-based techniques or plate-and-frame dewatering and filtration techniques, followed by conditioning through laydown and windrowing, debris removal, and screening to yield a sized DWTM fraction for agricultural or industrial use. In another aspect, the sized or further dried DWTM is pelletized by forming seed pellets in a pin mixer with a binder and moisture addition, growing pellets on a disc pelletizer to a target size, drying to achieve handling moisture and crush strength, screening to separate on-size product from non-conforming product, and recycling off-size fractions, thereby producing uniform pellets suitable for precise, low-dust application and broadened end uses.

In one embodiment of the present disclosure, a method of processing drinking water treatment material (DWTM) generated from a water treatment process, the method including receiving a first material generated from the water treatment process, wherein the first material includes water and DWTM, and wherein DWTM includes calcium carbonate and organic matter; transporting the first material to one or more processing locations; and dewatering the first material to form a dewatered mass of DWTM.

As aspects of some embodiments, DWTM further includes magnesium carbonate, iron, aluminum, and manganese.

As aspects of some embodiments, the method further includes conditioning the dewatered mass of DWTM, screening the conditioned DWTM to yield a sized DWTM fraction, and preparing the sized DWTM fraction for application.

As aspects of some embodiments, conditioning the dewatered mass of DWTM further includes laydown and drying of the dewatered mass.

As aspects of some embodiments, wherein the first material is transported to a processing location that is a dewatering facility, and wherein dewatering includes mechanically dewatering the first material to produce a filter cake of DWTM.

As aspects of some embodiments, the first material is transported to a processing facility that includes one or more lagoons, and wherein dewatering includes placing one or more pumps, one or more crocks, and one or more ditching systems in each of the one or more lagoons to remove free water from each lagoon.

As aspects of some embodiments, the method further includes further drying the conditioned DWTM prior to screening.

As aspects of some embodiments, the further drying occurs using a heat exchanger and a plate drying system.

As aspects of some embodiments, the method further including pelletizing the dewatered mass of DWTM, the pelletizing including providing a DWTM feed; introducing the DWTM feed and a binder into a mixer; adding a fluid to the mixer to form pellets of a first desired size; and transferring the pellets of the first desired size to a pelletizer to increase the pellets of the first desired size to a target size.

As aspects of some embodiments, the fluid is water.

As aspects of some embodiments, the pelletizer is a disc pelletizer.

As aspects of some embodiments, the DWTM feed has a moisture content of about 5% to about 8%.

As aspects of some embodiments, the binder is a lignin-based binder.

As aspects of some embodiments, the method further including drying the pellets of the target size in a dryer, screening the dried pellets to separate a desired product fraction from a non-conforming product, and recycling the non-conforming product to the mixer or pelletizer.

In another embodiment of the present disclosure, a method of processing drinking water treatment material (DWTM) generated from a water treatment process, the method including receiving a first material generated from the water treatment process, wherein the first material includes water and DWTM, and wherein DWTM includes calcium carbonate and organic matter; transporting the first material to one or more processing locations; dewatering the first material to form a dewatered mass of DWTM; and pelletizing the dewatered mass of DWTM.

As aspects of some embodiments, DWTM further includes magnesium carbonate, iron, aluminum, and manganese.

As aspects of some embodiments, the method further includes conditioning the dewatered mass of DWTM, screening the conditioned DWTM to yield a sized DWTM fraction, and preparing the sized DWTM fraction for application.

As aspects of some embodiments, pelletizing the dewatered mass of DWTM further includes providing a DWTM feed, introducing the DWTM feed and a binder into a mixer, adding a fluid to the mixer to form pellets of a first desired size; and transferring the pellets of the first desired size to a pelletizer to increase the pellets of the first desired size to a target size.

In yet another embodiment of the present disclosure, a pellet including drinking water treatment material (DWTM) originating from a water treatment process, wherein the pellet includes processed DWTM, wherein DWTM includes calcium carbonate and organic matter; and a lignin-based binder.

As aspects of some embodiments, the percent by weight of the processed DWTM in the pellet is 97-98 percent, and wherein the percent by weight of the lignin-based binder in the pellet is 2-3 percent.

### BRIEF DESCRIPTION OF THE DRAWINGS

The above-mentioned, and other features and objects of the disclosures, and the manner of attaining them will become more apparent and the disclosure itself will be better understood by reference to the following description of embodiments of the disclosure taken in conjunction with the accompanying drawings, wherein:

FIG. 1 is a flow diagram of a water treatment process producing DWTM according to an embodiment of the present disclosure;

FIG. 2 is another flow diagram of the water treatment process producing DWTM of FIG. 1;

FIG. 3 is a flow diagram of a method of processing drinking water treatment material in accordance with an embodiment of the present disclosure; and

FIG. 4 is a schematic flow diagram of a pelletization process in accordance with an embodiment of the present disclosure.

### DETAILED DESCRIPTION

The following description of technology is merely exemplary in nature of the subject matter, manufacture and use of one or more disclosures, and is not intended to limit the scope, application, or uses of any specific disclosure claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Drinking water treatment material (DWTM) is generally generated using an inorganic material comprised of calcium oxides and hydroxides (collectively referred to herein as “lime”) in a water softening process employed by water treatment plants to neutralize acidity and remove hardness from the water.

In various embodiments, the DWTM may include a wide range of inorganic and organic constituents arising from raw water quality, treatment chemistry, and solids handling conditions. In addition to calcium carbonate (CaCO₃), magnesium carbonate (MgCO₃), iron compounds, aluminum compounds (such as aluminum sulfate Al₂(SO₄)₃), manganese compounds, and dry matter, the DWTM may further include one or more of the following: calcium hydroxide (Ca(OH)₂), magnesium hydroxide (Mg(OH)₂), ferric hydroxide (Fe(OH)₃), ferrous hydroxide (Fe₂O₃), aluminum hydroxide (Al(OH)₃), manganese oxides (such as MnO₂ and MnOOH), silica, silicon dioxide (SiO₂), aluminosilicate minerals such as kaolinite, illite, and montmorillonite, phosphate species including orthophosphate, polyphosphate, and calcium phosphate, sulfate and chloride salts, bicarbonate, and trace metals such as zinc, copper, nickel, chromium, and lead in oxidized or hydroxide forms. The dry matter portion of the DWTM may additionally include natural organic matter such as humic acids, fulvic acids, lignin fragments, cellulose, hemicellulose, polysaccharides, proteins, amino acids, lipids, microbial biomass, extracellular polymeric substances, and residues of treatment chemicals including polyacrylamide flocculants, activated carbon fines, and polyphosphate corrosion inhibitors. Entrained mineral solids such as quartz, feldspar, clay fines, and silt may also be present. The foregoing constituents may be present individually or in combination, and in varying proportions, depending on the water source, treatment process, and solids handling practices employed.

In typical embodiments, the DWTM includes a high percentage of calcium carbonate (CaCO₃), generally ranging from about 70% to about 95% by weight on a dry solids basis, and in certain embodiments from about 85% to about 100% by weight. The balance of the material may include magnesium carbonate (MgCO₃) in amounts of about 1% to about 10% by weight, calcium hydroxide and magnesium hydroxide in amounts of about 0% to about 5% by weight each, aluminum and iron compounds such as aluminum hydroxide, aluminum sulfate, and ferric hydroxide in amounts of about 0.1% to about 5% by weight, manganese oxides in trace to minor amounts, silica and aluminosilicate minerals in amounts of about 1% to about 10% by weight, phosphate species in trace to minor amounts, and organic matter, including humic substances, microbial biomass, and polymeric treatment residues, in amounts of about 1% to about 10% by weight. Trace metals such as zinc, copper, nickel, chromium, and lead may also be present at low concentrations. It should be appreciated that the precise composition of DWTM varies based on raw water quality, treatment chemistry, and solids handling practices, and any such composition may be processed by the methods of the present disclosure.

Table 1 below provides an exemplary composition of DWTM on a dry-solids basis. It should be appreciated that the precise composition of DWTM varies depending on raw water quality, lime type, coagulant selection, and solids-handling practices, and that any such composition may be processed using the methods of the present disclosure.

TABLE 1
Exemplary Composition of Drinking Water Treatment
Material (DWTM) (All percentages expressed
as weight percent on a dry-solids basis)

| | Typical Range |
|---|---|
| Component | (wet ton %) |
| Calcium carbonate (CaCO₃) | 70-95% |
| Magnesium carbonate (MgCO₃) | 1-10% |
| Calcium hydroxide (Ca(OH)₂) | 0-5% |
| Magnesium hydroxide (Mg(OH)₂) | 0-5% |
| Aluminum compounds (Al(OH)₃, | 0.1-5% |
| Al₂(SO₄)₃) | |
| Iron compounds (Fe(OH)₃, Fe₂O₃) | 0.1-5% |
| Manganese oxides (MnO₂, MnOOH) | Trace-1% |
| Silica and aluminosilicates (SiO₂, | 1-10% |
| clays) | |
| Phosphate species (PO₄³⁻, | Trace-3% |
| polyphosphates) | |
| Organic matter (humics, biomass, | 1-10% |
| EPS) | |
| Activated carbon fines | Trace-2% |
| Trace metals (Zn, Cu, Ni, Cr, Pb) | ppm-level to <0.1% |
| Other entrained solids (sand, silt, grit) | Trace-5% |

DWTM generally has a high pH value, making it alkaline and high value CaCO₃, which is beneficial for agricultural use. In an embodiment, DWTM has a pH value of around 8.7. DWTM also contains organic matter which is beneficial for blending with clay or sandy soils with low organic matter and an advantage in agricultural use because conventional chemical lime does not contain organic matter and therefore, the conventional chemical lime does not promote the growth of vegetation as well as DWTM.

DWTM is often referred to as softening lime or calcium carbonate sludge, and has characteristics favorable for creating calcareous soil, which is essential for wetland creation. The high calcium content makes it suitable for various agricultural, industrial, and environmental applications. For example, DWTM may be used to improve soil pH and structure, particularly in acidic soils, and can be used as Marl soil in wetland and stream mitigation projects. The benefits include enhanced crop yields, improved soil fertility and reduced soil acidity. DWTM is particularly effective when incorporated into engineered media for bioretention systems and permeable reactive barriers.

As another non-limiting example, DWTM also helps retain and absorb phosphorus and other pollutants from stormwater runoff, improving water quality. DWTM can be used in various stages of wastewater treatment to remove contaminants such as heavy metals and suspended solids. DWTM also enhances the efficiency of wastewater treatment processes and improves effluent quality. DWTM may also act as a stabilizing agent in the production of concrete and bricks, and for soil stabilization in construction projects. It also improves the durability and strength of construction materials and provides a sustainable alternative to traditional materials. Further, DWTM can be applied to agricultural fields to improve soil conditions and reduce the impact of residual herbicides or a base for agricultural field restoration beneath topsoil layers. The benefits of using DWTM include enhanced soil fertility, reduced herbicide carryover, and the promotion of sustainable agricultural practices. DWTM may also have further beneficial applications as recognized by one skilled in the art.

Additionally, the use of DWTM offers several environmental and economic benefits. Use of DWTM in various applications diverts significant quantities of spent lime from landfills, reducing disposal costs and environmental impact. The use of DWTM also provides a sustainable alternative to virgin materials, conserving natural resources. Further, the DWTM reduces the need for chemical fertilizers and other soil amendments, lowering costs for farmers and municipalities. DWTM may also provide further environmental and economic benefits as recognized by one skilled in the art.

In particular, and as a non-limiting example, the beneficial extraction and use of DWTM from municipal water treatment plants offers a sustainable solution to waste management challenges. By using this byproduct, municipalities can reduce disposal costs, conserve natural resources, and promote environmental sustainability. Further research and collaboration among stakeholders are essential to maximize the potential of DWTM and overcome associated challenges of regulatory compliance, maintain quality control, and improve public perception.

Embodiments of the present disclosure implement a variety of means and methods to transform a waste material into a value added, market demanded agricultural product. In certain embodiments, the method uses conditioning, agronomic techniques, and science and engineering efforts to make DWTM a valuable product for agricultural use. By reducing moisture content, increasing solid content, and ensuring proper sorting of foreign debris, the method of the present disclosure may aid municipalities in reducing their costs associated with what was once considered a waste stream and instead now created economic value. The presently described methods of conditioning, sorting, and further processing DWTM focuses on the equipment and processes used to create a salable product and highlights the agricultural applications of DWTM. While the presently described methods highlights the agricultural applications of DWTM, it should be appreciated that the processed DWTM may be utilized in a vast array of applications, and reference to agricultural applications of DWTM should not be construed as limiting.

DWTM is a byproduct of the lime softening process, where lime is added to water to remove hardness-causing ions. This lime softening process often occurs during the water treatment processes occurring in water treatment facilities. The resulting DWTM contains calcium carbonate, magnesium hydroxide, and/or other trace minerals beneficial to soil conditioning.

A typical water treatment process 100 occurring at a water treatment facility (not illustrated) is herein described for exemplary purposes. It should be appreciated that DWTM may be produced from a wide array of water treatment processes, and reference to the exemplary process herein should not be construed as limiting.

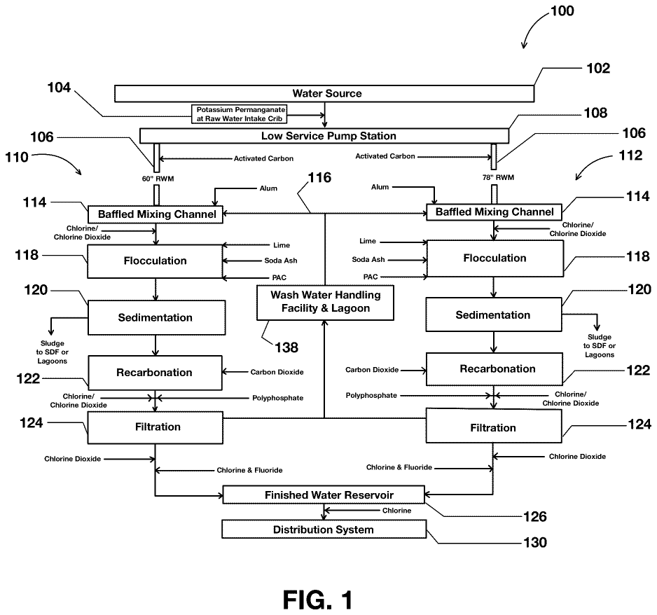

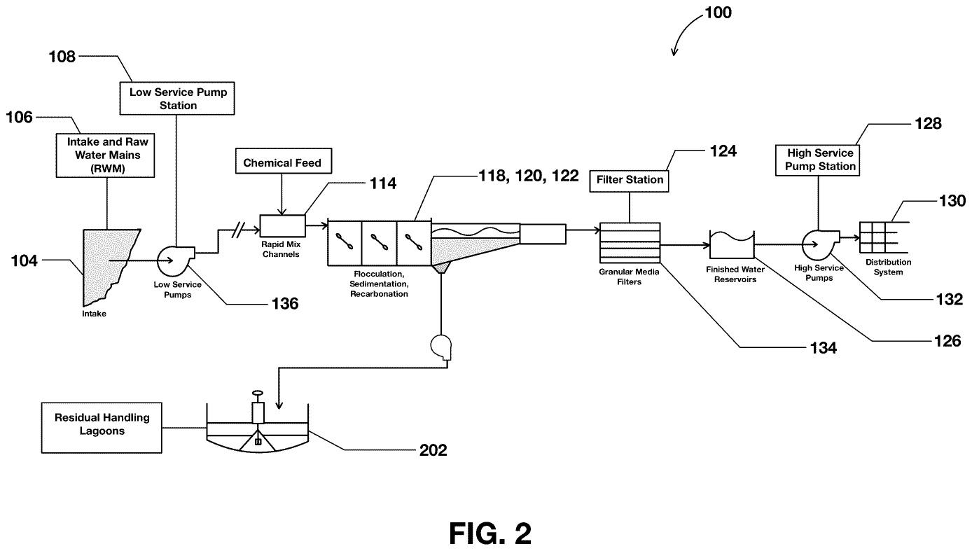

FIGS. 1 and 2 illustrate a flow diagram of a water treatment process 100 producing DWTM according to an exemplary embodiment of the disclosure. In this embodiment, raw surface water is collected from a water source 102 at a raw water intake crib 104. The water source 102 may be any water source, such as a lake, a river, a reservoir, or any other water source as desired, as non-limiting examples. In an exemplary embodiment, the water source 102 is a fresh water lake. The raw surface water collected is then conveyed via intake (not illustrated) and one or more raw water mains (RWM) 106 to a low service pump station 108 equipped with one or more low service pumps 136 sized for plant flow range. The water treatment process 100 may be configured to receive flow of water from the water source 102 at any rate as desired. In an exemplary embodiment, the water treatment process 100 is configured to receive a flow of water from the water source 102 at a rate of 120 million gallons per day (MGD).

The intake is configured to receive potassium permanganate and activated carbon dosing upstream or at the raw water intake crib 104 to address manganese oxidation and taste and odor control. The low service pump station 108 then pumps the conditioned raw water through the raw water mains 106 and to the plant headworks. In an exemplary embodiment, the low service pump station 108 splits the flow of raw water at the plant headworks into two parallel treatment lines, with a first treatment line 110 being sized smaller than a second treatment line 112. In an exemplary embodiment, the first treatment line 110 has a raw water main 106 that is 60 inches (in.) in diameter, and the second treatment line 112 has a raw water main 106 that is 78 in. in diameter. The parallel treatment lines 110, 112, in an embodiment, are identical treatment lines with the only difference between the treatment lines being sizing. However, the parallel treatment lines 110, 112 of the exemplary embodiment will be described as being identical and having the same reference numerals, with sizing differences being highlighted where necessary.

The low service pump station 108 pressurizes, divides, and pumps the conditioned raw water through the various raw water mains 106 to one or more baffled mixing channels 114. In the one or more baffled mixing channels 114, an aluminum compound is added to the conditioned raw water. The addition of the aluminum compound serves to coagulate the conditioned raw water. The baffled mixing channels 114 are configured to promote high-energy dispersive mixing immediately after chemical addition, enabling effective destabilization of colloids and initial oxidation reactions. One or more recycle lines 116 containing recycled wash water may also feed the baffled mixing channels 114.

Downstream of the baffled mixing channels 114, but before the flow is introduced to one or more flocculation basins 118, chlorine and/or chlorine dioxide is introduced to the mixture. The addition of chlorine dioxide and chorine provides the mixture with oxidation and acts as a disinfection precursor. Once the chlorine and chlorine dioxide is introduced, the mixture is fed into the one or more flocculation basins 118, where lime, soda ash, and poly aluminum chloride (PAC), collectively referred to herein as a flocculant, are introduced into the mixture to aid in the flocculation process. PAC is added to provide better adsorption, and soda ash and lime are added to adjust alkalinity and pH to optimize downstream flocculation and precipitation.

Once the flow enters the flocculation basins 118 and is mixed with the flocculant, the process of flocculation occurs, creating flocs. Flocs are clumps of particles that are formed during the flocculation process which are essential for removing suspended solids from water. The flocs may be comprised of the flocculant and suspended solids, amongst other compositions as desired, which are desirable to be removed from the flow of water during the water treatment process 100. In an embodiment, the flocculation basin 118 of the first treatment line 110 includes only two basins, where the flocculation basin 118 of the second treatment line 112 includes four basins. Basin trains can be operated together or independently to match flow and raw water quality conditions, providing operational flexibility and redundancy.

Effluent from the one or more flocculation basins 118 is then conveyed to a sedimentation process 120 comprising one or more clarifiers or one or more sedimentation basins sized in multiple units to accommodate the flows from the flocculation basins 118. In an embodiment, the sedimentation process 120 of the first treatment line 110 includes only two sedimentation basins, where the sedimentation process 120 of the second treatment line 112 includes four sedimentation basins. The sedimentation process 120 generally includes allowing the flocs from the effluent to settle to the bottom of the sedimentation basins while clarified water, with flocs removed, proceed to downstream processes. The clarified water then proceeds downstream following the sedimentation process, while settled sludge containing flocs is collected and pumped to a sludge dewatering facility (SDF) or to residual handling lagoons 202 for storage and further dewatering as needed. The sedimentation process may also include one or more dedicated sedimentation lagoons to buffer solids handling operations and to decouple variable sludge production from downstream dewatering equipment duty cycles. It should be noted that the settled sludge containing flocs may also be referred to as DWTM or lime sludge, spent lime, or lime residuals.

Downstream of the sedimentation process 120, the clarified water is directed to one or more recarbonation basins 122, again arranged in parallel trains (e.g., two-basin and four-basin configurations). Within the recarbonation basins 122, carbon dioxide is injected into the clarified water to adjust the carbonate system and to stabilize pH, while polyphosphate is dosed to provide corrosion control and sequestration benefits in the distribution system. Chlorine dioxide and chlorine feed points are also available at this stage of the process for additional oxidation or residual management prior to filtration. The recarbonation basins 122 enables fine control of water chemistry under varying influent conditions and flow rates.

The recarbonated water then proceeds downstream to one or more filter systems 124 comprising one or more granular media filters 134. In one embodiment, the first treatment line 110 includes ten filters, and the second treatment line 112 includes twenty filters. The filter systems 124 are fed via filter feed pumps (not illustrated), and wash water handling is further recycled through the one or more recycle lines 116 from the filter systems 124 back to the baffled mixing channels 114. In some embodiments, the recycled wash water enters a wash water handling facility and lagoon 138 for further handling and processing before the wash water is recycled to the baffled mixing channels 114.

Post-filtration, the water treatment process 100 provides chlorine dioxide and chlorine addition points to the system to establish and maintain disinfectant residuals, as well as fluoride addition to achieve community fluoridation goals. Treated water is conveyed to one or more finished water reservoirs 126, which in one embodiment includes two reservoirs with aggregate storage capacity on the order of approximately 70 million gallons. From the finished water reservoirs 126, a high service pump station 128 pumps finished water through one or more high service pumps 132 to the distribution system 130 through one or more distribution mains.

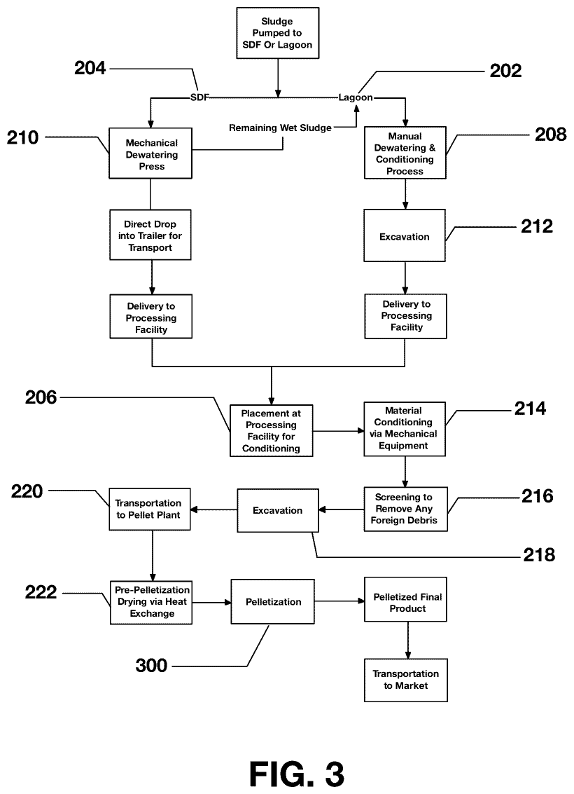

FIG. 3 depicts a flow diagram of an exemplary method of processing DWTM in accordance with an embodiment of the present disclosure. It should be appreciated that certain embodiments of the present disclosure employ multiple methodologies to ensure the DWTM is suitable for agricultural application.

In an exemplary embodiment, the sludge separated from clarified water during the flocculation process requires additional processing before the DWTM extracted from the sludge can be transported. In one embodiment, the sludge is conveyed to one or more residual handling lagoons 202 for storage and undergoing a manual dewatering and conditioning process 208 prior to transportation to a processing facility 206. In another embodiment, the sludge is transferred to a sludge dewatering facility (SDF) 204 for mechanical dewatering 210 prior to transportation to a processing facility 206.

When the sludge containing the DWTM is pumped to the one or more residual handling lagoons 202 after being extracted from the clarified water during the flocculation process, the sludge containing the DWTM undergoes a manual dewatering and conditioning process 208.

The manual dewatering and conditioning process 208, in an embodiment, may occur using any dewatering process as desired. Dewatering is a critical step in conditioning DWTM to increase its solid content and reduce moisture. DWTM contains high moisture levels, making it difficult to transport and apply effectively. The goal of the dewatering process is to remove excess water, which not only enhances its value but also reduces transportation costs. In an exemplary embodiment, dewatering within the one or more lagoons is facilitated by strategic placement of pumps and crocks and by engineered ditching to remove free water and increase solids content for removal. For example, each lagoon may be constructed with compacted earthen berms and, in certain embodiments, with a geomembrane or liner to minimize infiltration. Once the sludge has been pumped into the one or more lagoon, and once the flocs within the sludge containing the DWTM have settled to the bottom of each lagoon, the one or more lagoons are then drained in stages. In an embodiment, the free water to be removed from the one or more lagoons is withdrawn using one or more floating suction skimmers and/or one or more electric pumps positioned to remove water from the very top of each lagoon. It should be appreciated, however, that the skimmers or pumps may be any skimmers or pumps as desired.

Additionally, one or more perforated vertical crocks are set into the lagoon with geotextile wraps, in an embodiment, to screen out finer materials. Crocks may be located on a grid and connected to a header or directly pumped using submersible solids-handling pumps equipped with variable frequency drives to modulate drawdown rates. However, it should be appreciated that any crocks may be used in this process as desired. Further, to route accumulated water toward collection points without disturbing the sludge mat containing the dewatered DWTM, one or more shallow ditches or trenches are cut into each lagoon with low-ground-pressure equipment.

Once the DWTM has been dewatered, the dewatered material then undergoes strict quality control and conditioning to remove foreign debris through visual inspection and manual sorting to minimize risk to soil and application equipment and to elevate the material from a waste to a salable commodity. This is a labor-intensive process as it also involves the use of equipment, such as excavators, frontend loaders, pumps and shovels, as non-limiting examples, to manually sort through DWTM and segregate any possible areas of contamination. While visual inspection and manual labor is used for this portion of the process, this process may be alternately mechanized so that the foreign debris may be removed automatically and/or without manual labor. Additionally, any conditioning process may be utilized as desired, with the described method serving as a non-limiting example.

After undergoing the manual dewatering and conditioning process 208, the conditioned mass is excavated 212 with bucket blades to minimize disturbance of the settled structure and loaded for transport to the processing facility 206. There, the material may be laid down in windrows to promote natural drying and aeration, with periodic turning using chisel disks to increase surface area exposure and accelerate evaporation. Dewatering and windrow conditioning increase solids content, reduce bulk weight, and improve agronomic value as the concentration of beneficial constituents increases.

In additional embodiments, the sludge containing the DWTM is transferred from the water treatment process 100 to the SDF 204 for mechanical dewatering 210 prior to transport to a processing facility 206. Mechanical dewatering 210 may be performed using any solids liquid separation technology suitable for high calcium residuals, and is not limited to a single equipment type. In one exemplary embodiment, mechanical dewatering 210 utilizes a plate-and-frame filter press configured with recessed plates, membrane squeeze plates, or a combination thereof. The press may operate in manual, semi automatic, or fully automatic modes and may include cloth washing systems, core blow systems, air blow drying cycles, or membrane squeeze cycles to increase solids content. The plate-and-frame process compresses the sludge between a plurality of filter plates under hydraulic pressure to expel free water and produce a semi-solid filter cake of DWTM having a significantly reduced moisture content.

In other embodiments, multiple plate-and-frame presses may be operated in parallel to increase throughput, provide redundancy, or accommodate variable sludge production rates. The presses may be arranged in banks, operated in staggered cycles, or integrated with upstream sludge conditioning systems such as polymer dosing, lime reactivation, or pH adjustment to optimize dewatering performance. Alternative mechanical dewatering equipment may also be employed, including belt filter presses, screw presses, rotary presses, decanter centrifuges, or geotextile tube dewatering systems, each of which may be selected based on site-specific constraints, solids characteristics, or operational preferences.

In further embodiments, the mechanically dewatered DWTM may undergo thermal conditioning to achieve additional moisture reduction. Thermal drying may be accomplished using one or more heat exchangers, plate dryers, conduction dryers, or indirect drying systems configured to transfer thermal energy to the DWTM without direct combustion gas contact. Suitable systems include, as non-limiting examples, hollow flight dryers, disc dryers, paddle dryers, or plate type heat exchangers that apply controlled heat to evaporate residual moisture while maintaining the structural integrity of the solids. The thermal drying system may operate using steam, hot water, thermal oil, waste heat recovery, or other heat sources. The use of thermal energy reduces the moisture content of the DWTM to improve handling characteristics, increase bulk density, enhance flowability, and reduce transportation costs.

In certain embodiments, the thermal drying system may be integrated with the mechanical dewatering 210 system to form a hybrid dewatering train. For example, filter cake discharged from a plate-and-frame press may be conveyed directly to a plate dryer or heat exchanger for secondary moisture removal. In other embodiments, the thermal drying system may include staged or multi-zone temperature control, air recirculation, or exhaust-gas treatment to optimize energy efficiency and maintain product quality. The resulting dried DWTM may exhibit a moisture content suitable for downstream conditioning, screening, or pelletization, depending on the intended application of the dried DWTM.

It is understood that various other dewatering methods may be employed to increase a solid content and reduce moisture in the DWTM.

After undergoing either dewatering process, the dewatered DWTM is transported to the processing facility 206. The dewatered DWTM may then be laid down and conditioned at the processing facility 206. A laydown area at the processing facility 206, in an embodiment, is employed to serve as a recycling center for processing DWTM and various aspects of conditioning material. In an embodiment, a windrowing technique may be employed to form the material into long rows to enhance drying through natural processes. By laying the material out in rows, the surface area of the DWTM material is increased, promoting faster evaporation of residual moisture to natural environments. Windrowing helps to aerate the material, reducing the risk of anaerobic conditions that can degrade its quality. Using specialized equipment such as chisel disks, the material is arranged in long rows and periodically turned to enhance drying and aeration. Chisel disks are used to cut through the material, breaking it up and exposing it to air, which accelerates drying.

After drying to a target handling moisture of about 25% to about 40% moisture by weight, in an exemplary embodiment, further conditioning 214 of the DWTM is required and, in an embodiment, may involve mechanical equipment and/or screening the material. In an exemplary embodiment, manual conditioning, that is the removal of foreign debris through visual inspection and manual sorting, may be employed.

In another exemplary embodiment, further conditioning 214 of the DWTM following windrow drying may be performed using a combination of mechanical agitation, debris separation, and controlled material handling to achieve a uniform, application ready product. In one embodiment, the partially dried DWTM is first formed into elongated windrows and allowed to equilibrate to a target handling moisture. The windrows are then mechanically turned using a tractor mounted windrow turner, chisel disk, or similar implement, as non-limiting examples, to promote aeration, homogenize moisture distribution, and expose entrained debris. Following turning, the material is conveyed or pushed to a staging area where foreign debris, including rocks, wood fragments, plastics, vegetation, and oversized agglomerates, is removed using a front-end loader, for example, equipped with a rake bucket, grapple bucket, or debris screening attachment. Other conditioning methods, however, may be employed as desired.

In certain embodiments, once conditioned 214, the DWTM goes through a screening 216 process. Screening 216 of the DWTM ensures that any foreign debris, such as rocks or wood, is removed before it is processed further or sent out for agricultural use. Screening 216 is an essential part of quality control as foreign materials can damage application equipment or negatively impact soil conditions, During this process, the DWTM may be passed through a mechanical screener, such as vibrating deck screens or rotating trommel screens, to separate fine, agronomically suitable fractions from oversized or non-conforming material. Trommel screens are rotating cylindrical screens that effectively sort DWTM by particle size, with finer material passing through and larger debris retained. Once the DWTM is conditioned 214 and screened 216, the screened fraction may then be stockpiled, blended, or directly loaded for agricultural or industrial application, while oversized material is either discarded, reprocessed, or returned to the windrow for additional drying and breakdown.

After the DWTM is conditioned 214 and screened 216, it can be applied to agricultural fields using specialized equipment. Application utilizes agricultural industry preferred Variable Rate Technology (VRT) spreaders that are equipped with GPS and advanced technology. These spreaders can apply the lime at varying rates across a field, ensuring optimal coverage and resource use. Accordingly, the use of VRT spreaders ensures that the DWTM is applied to the agricultural fields in precise amounts, targeting areas that need pH adjustment or soil improvement. DWTM is an excellent source of calcium carbonate, which neutralizes acidic soils, improving plant growth and nutrient availability. The fine particles help to improve soil tilth and water retention better than that of typical quarried agricultural lime.

Alternatively, the conditioned 214 and screened 216 DWTM may be excavated 218 using any desired method, including through using bucket blades as a non-limiting example, and/or loaded directly onto trucks for transport 220 to a facility for pelletization 300. The most advanced processing and conditioning of DWTM is to put it through a pelletization 300 process.

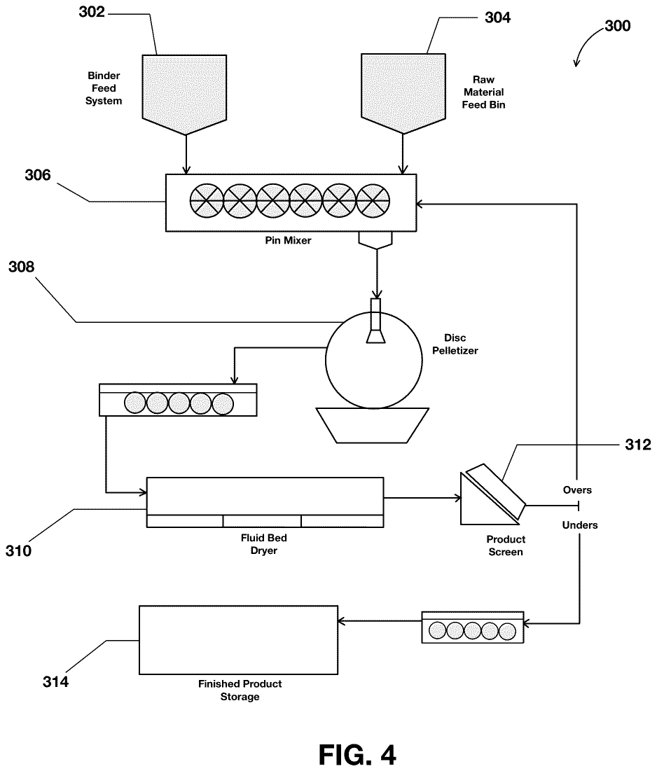

FIG. 4 illustrates an exemplary pelletization 300 process according to an embodiment of the present disclosure. The pelletization 300 process involves compressing the material into small pellets that are easier to spread and apply using conventional agricultural equipment. In certain instances, the pellets are generally uniform granules suitable for various industrial and environmental applications. For example, pelletized DWTM may have utility in several industrial processes, including: soil stabilization due to its high calcium content which strengthens soils in construction projects; neutralization of acidic waste streams in manufacturing due to its alkaline properties; and as a binding agent due to its cohesive properties which enable its use as a binder in producing cementitious materials. Pelletized DWTM can also have environmental application. Particularly, the pelletized DWTM targets phosphorus runoff reduction. Phosphorus pollution from agricultural and urban runoff contributes to eutrophication in water bodies, causing algal blooms and degrading aquatic ecosystems. Additionally, pelletized DWTM may be suitable for agricultural purposes since it can be applied more evenly across fields and reduces the risk of dust, which can be problematic with finer powders. Pelletization 300 controls the release rate of nutrients into the soil, providing a more sustained benefit over time. The pelletized DWTM can be integrated into buffer strips or constructed wetlands to intercept runoff before it reaches waterways. The use of biodegradable geotextile mat systems that will house the pelletized DWTM will be placed in agricultural fields alongside ditches and drainage channels and deployed as temporary phosphorus filters in high-risk areas seasonally.

FIG. 4 schematically illustrates a pelletization 300 circuit comprising a raw material feed bin 302, a binder feed system 304, a pin mixer 306 to form seed pellets, a disc pelletizer 308 to grow pellets to target size, a fluid-bed dryer 310 to achieve final moisture and crush strength, a product screen 312 to separate a product fraction from undesired product sizes, and finished product storage 314. The undesired product size product fraction is, in an exemplary embodiment, recycled to the mixer or pelletizer for size control.

In some embodiments, prior to pelletization 300, the DWTM must be further dried 222. In an embodiment, the DWTM is further dried 222 through use of a heat exchange method, which may be any heat exchange method as desired. In an embodiment, one or more heat exchangers are used to dry 222 the DWTM prior to pelletization 300. In an exemplary embodiment, the prepared DWTM is metered into a thin-layer plate dryer heated by a thermal drying system. The thermal drying system may include staged or multi zone temperature control, air recirculation, or exhaust gas treatment to optimize energy efficiency and maintain product quality. The dryer operates in through-circulation or crossflow, with supply air at about 90-180° C. and exhaust air at about 50-100° C., under slight negative pressure maintained by an induced-draft fan connected to a baghouse for dust capture. Material is conveyed across multiple heated plates by vibratory motion to avoid agglomeration.

Once the DWTM has been dried to the desired specification, then the dried DWTM is placed into the raw material feed bin 302. The desired specification of the DWTM prior to pelletization 300, in an embodiment, is 5-8% moisture content.

A binder is also placed into the binder feed system 304. The binder may be any binder as desired. In an exemplary embodiment, the binder introduced into the binder feed system 304 may comprise a lignin-based binder. Lignin binders are typically derived from a sulfite pulping process and may include lignosulfonates such as calcium lignosulfonate, sodium lignosulfonate, ammonium lignosulfonate, or magnesium lignosulfonate. These materials contain sulfonated lignin polymers that exhibit strong adhesive properties, enabling agglomeration of fine DWTM particles during seed-pellet formation and subsequent pellet growth. In certain embodiments, the binder may be present in an amount of about 1% to about 6% by weight of the total pellet formulation. In an exemplary embodiment, the binder may be present in an amount about 2% to about 3% by weight of the total pellet formulation, depending on the solids content, particle size distribution, and desired crush strength of the finished pellets.

Lignin-based binders are advantageous because they provide high green-strength during pellet formation, improve pellet durability during drying and handling, reduce dust generation, and are compatible with agricultural applications due to their biodegradability and low environmental impact. Lignosulfonates also act as dispersants and wetting agents, facilitating uniform moisture distribution within the pelletizer and promoting consistent pellet growth.

In other embodiments, alternative binders may be used in place of or in combination with lignin-based binders. Suitable alternatives include, but are not limited to, molasses, starch-based binders (such as corn starch or potato starch), protein-based binders, bentonite clay, attapulgite clay, gypsum, cementitious binders, polyvinyl alcohol (PVA), carboxymethyl cellulose (CMC), or other organic or inorganic agglomeration aids known in the art as non-limiting examples. The selection of binder may depend on the intended end use of the pellets, regulatory considerations, desired pellet hardness, dust suppression requirements, or cost constraints. In certain embodiments, combinations of binders may be employed to balance green-strength, drying efficiency, and final pellet durability as desired.

Formation of the DWTM pellets then begins in the horizontal pin mixer 306. It should be appreciated that any mixer may be used as desired. The dried DWTM and the binder are fed into the pin mixer 306 at a defined ratio of DWTM to binder. In an exemplary embodiment, the DWTM to binder ratio fed into the pin mixer 306 is about 94% to about 98% by weight DWTM and about 2% to about 6% by weight binder. In another exemplary embodiment, the DWTM to binder ratio fed into the pin mixer 306 is about 96% to about 98% by weight DWTM and about 2% to about 4% by weight binder, based on the total solids entering the mixer. However, it should be appreciated that the DWTM to binder ratio fed into the pin mixer 306 may be any ratio as desired.

Additionally, in an embodiment, a mixer speed of the pin mixer 306 is set to provide a tip speed of about 3 m/s to about 15 m/s, which for a typical horizontal pin mixer 306 corresponds to a shaft rotational speed of about 200 revolutions per minute (rpm) to about 800 rpm. A residence time of the materials in the mixer is about 10 seconds to about 120 seconds, and more particularly, in an exemplary embodiment, about 20 seconds to about 60 seconds. However, it should be appreciated that the mixer speed and residence time may be any mixer speed and residence time as desired. These specifications are selected to promote micro agglomeration of the dried DWTM particles into dense, nearly spherical seed pellets while avoiding over wetting, excessive breakage, or the formation of large, irregular agglomerates.

The mixed material is then transferred to a disc pelletizer 308 for growth to the target pellet size. The disc angle of the disc pelletizer 308 may be set, for example, between about 38-55 degrees from horizontal, and the rotation speed may be adjusted (e.g., 3-25 rpm for a 3-5 m diameter disc, as a non-limiting example) to maintain a rolling bed depth suitable for layering growth mechanisms. A dedicated spray zone applies additional binder and/or water to control surface plasticity. In an exemplary embodiment, the disc pelletizer is operated with a disc angle of about 40 degrees to about 55 degrees relative to horizontal, and a rotational speed of about 3 to about 15 revolutions per minute, with a binder and water spray rate corresponding to about 5% to about 20% by weight of the incoming dry DWTM feed. In further embodiments, a recycle stream of previously formed pellets or off size granules is returned to the disc at a recycle to fresh feed mass ratio of about 1:1 to about 4:1. These process variables are coordinated to maintain a stable rolling bed, provide sufficient free surface moisture for pellet growth, and produce pellets having a particle size distribution corresponding to about a 5 mm mesh (approximately a 2-4 mm pellet size in circumference) while minimizing bed slumping and dust generation. The process variables, however, may be adapted as desired to produce various sized pellets.

The formed pellets then discharge to a primary dryer 310, which in some embodiments is a fluid-bed dryer providing gentle, uniform convective drying to a final moisture compatible with downstream handling and target crush strength. In an embodiment, 1500 British thermal units (BTUs) per pound of water evaporated is required when removing moisture from the pellets. Fluidization air may be supplied at about 80-160° C., with a superficial velocity selected to achieve bubbling or turbulent fluidization without elutriating on-size pellets. Residence time may be about 5-25 minutes depending on inlet moisture and bed depth. Exhaust air passes through cyclones and a baghouse for particulate control and may be routed to heat recovery or thermal oxidation if required by air permits. In other embodiments, a rotary dryer may be used with internal lifters designed to minimize pellet attrition.

The dried pellets are then put through size classification on a multi-deck vibratory product screen 312. The product screen 312 utilizes a top deck which scalps oversize material (greater than the 5 mm mesh size desired, in an exemplary embodiment), which is recycled to the pin mixer or directly to the disc pelletizer feed, while a lower deck advances on-size product (about 2-4 mm) to finished product storage 314. Finished product storage 314 may be any storage facility or space suitable for DWTM pellets. At the end of the pelletization process, the final 2-4 mm pellet, in an exemplary embodiment, dries to a strength of about 4.12 pounds with a lignin binder.

It is understood that various other machines, techniques, and methods may be employed during the pelletization process to produce a DWTM of appropriate size for a desired application.

With the appropriate equipment and processes, the method of the present disclosure significantly reduces the cost of disposal while creating a valuable soil amendment. It also reduces the environmental impact and offsets the need for chemical fertilizers, benefitting both the farmers and the environment.

Among other benefits, the processing of DWTM from water treatment plants creates significant value by transforming a waste product into a beneficial soil amendment. Through the method of the present disclosure, comprising processes such as dewatering, windrowing, screening, and pelletizing, users can reduce disposal costs through the development of agricultural programs. The careful use of equipment like bucket blades, chisel disks, and trommel screeners ensures the product is of high quality and free of contaminants. Applied using advanced technologies like VRT, the DWTM becomes a sustainable, salable product that benefits both agriculture and the environment.

From the foregoing description, one ordinarily skilled in the art can easily ascertain the essential characteristics of this disclosure and, without departing from the spirit and scope thereof, can make various changes and modifications to the disclosure to adapt it to various usages and conditions.

What is claimed is:

1. A method of processing drinking water treatment material (DWTM) generated from a water treatment process, the method comprising:
receiving a first material generated from the water treatment process, wherein the first material comprises water and DWTM, and wherein DWTM comprises calcium carbonate and organic matter;
transporting the first material to one or more processing locations; and
dewatering the first material to form a dewatered mass of DWTM.

2. The method of claim 1, wherein DWTM further comprises magnesium carbonate, iron, aluminum, and manganese.

3. The method of claim 1, wherein the method further comprises conditioning the dewatered mass of DWTM, screening the conditioned DWTM to yield a sized DWTM fraction, and preparing the sized DWTM fraction for application.

4. The method of claim 3, wherein conditioning the dewatered mass of DWTM further comprises laydown and drying of the dewatered mass.

5. The method of claim 1, wherein the first material is transported to a processing location that is a dewatering facility, and wherein dewatering comprises mechanically dewatering the first material to produce a filter cake of DWTM.

6. The method of claim 1, wherein the first material is transported to a processing facility that comprises one or more lagoons, and wherein dewatering comprises placing one or more pumps, one or more crocks, and one or more ditching systems in each of the one or more lagoons to remove free water from each lagoon.

7. The method of claim 3, further comprising further drying the conditioned DWTM prior to screening.

8. The method of claim 7, wherein the further drying occurs using a heat exchanger and a plate drying system.

9. The method of claim 1, further comprising pelletizing the dewatered mass of DWTM, the pelletizing comprising:
providing a DWTM feed;
introducing the DWTM feed and a binder into a mixer;
adding a fluid to the mixer to form pellets of a first desired size; and
transferring the pellets of the first desired size to a pelletizer to increase the pellets of the first desired size to a target size.

10. The method of claim 9, wherein the fluid is water.

11. The method of claim 9, wherein the pelletizer is a disc pelletizer.

12. The method of claim 9, wherein the DWTM feed has a moisture content of about 5% to about 8%.

13. The method of claim 9, wherein the binder comprises a lignin-based binder.

14. The method of claim 9, further comprising drying the pellets of the target size in a dryer, screening the dried pellets to separate a desired product fraction from a non-conforming product, and recycling the non-conforming product to the mixer or pelletizer.

15. A method of processing drinking water treatment material (DWTM) generated from a water treatment process, the method comprising:
receiving a first material generated from the water treatment process, wherein the first material comprises water and DWTM, and wherein DWTM comprises calcium carbonate and organic matter;
transporting the first material to one or more processing locations;
dewatering the first material to form a dewatered mass of DWTM; and
pelletizing the dewatered mass of DWTM.

16. The method of claim 15, wherein DWTM further comprises magnesium carbonate, iron, aluminum, and manganese.

17. The method of claim 15, wherein the method further comprises conditioning the dewatered mass of DWTM, screening the conditioned DWTM to yield a sized DWTM fraction, and preparing the sized DWTM fraction for application.

18. The method of claim 15, wherein pelletizing the dewatered mass of DWTM further comprises providing a DWTM feed, introducing the DWTM feed and a binder into a mixer, adding a fluid to the mixer to form pellets of a first desired size; and transferring the pellets of the first desired size to a pelletizer to increase the pellets of the first desired size to a target size.

19. A pellet comprising drinking water treatment material (DWTM) originating from a water treatment process, wherein the pellet comprises:
processed DWTM, wherein DWTM comprises calcium carbonate and organic matter; and
a lignin-based binder.

20. The pellet of claim 19, wherein the percent by weight of the processed DWTM in the pellet is 97-98 percent, and wherein the percent by weight of the lignin-based binder in the pellet is 2-3 percent.
